(19) United States
(12) Patent Application Publication
(10) Pub. No.: US 2005/0185748 A1
(43) Pub. Date: Aug. 25, 2005

(54) Methods and apparatus for monitoring frequency corrections in a clock and data recovery phase-lock loop, and for deriving operating indications therefrom

(76) Inventors: Mark Alvis Wahi, Windsor, CO (US); James Oliver Barnes, Fort Collins, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/786,399

(22) Filed: Feb. 24, 2004

(51) Int. Cl. H04L 7/00

(52) U.S. Cl. 375/376

(57) ABSTRACT

Frequency corrections made by a clock and data recovery phase-lock loop are monitored. For each of a number of time periods, the numbers of up and down frequency corrections that were made by the phase-lock loop during the time period are netted together. One or more operating indications are then derived from the net numbers. The operating indications may include: an indication of whether any net number is non-zero, an indication of whether any net number exceeds one or more thresholds, the value of one or more maximum net numbers, and/or the values of all net numbers. In one embodiment, operating indications are output to built-in self-test hardware. By way of example, the operating indications can be used to infer the existence and/or magnitude of anomolous events in 1) the phase-lock loop, or 2) the data that is being recovered under control of the phase-lock loop.

### BACKGROUND

During the operation of a clock and data recovery phase-lock loop, anomolous events in a received data stream may require the loop to make transient frequency corrections in the recovered clock. Exemplary anomalous events are phase and/or frequency steps in the received data stream.

During the time the phase-lock loop is responding to an anomolous event, the error rate in recovered data can be expected to rise. Some means to infer the existence and/or magnitude of such error would be desirable.

### SUMMARY

One aspect of the invention is embodied in a method wherein the number of up and down frequency corrections made by a phase-lock loop are monitored. For each of a number of time periods, the numbers of up and down frequency corrections made by the phase-lock loop during the time period are netted together. One or more operating indications are then derived from the net numbers.

Another aspect of the invention is embodied in apparatus comprising an accumulator stage, a timer and some logic. The accumulator stage i) receives up and down frequency corrections from a clock and data recovery phase-lock loop, and then ii) for each of a number of time periods, nets together the numbers of up and down frequency corrections that were received during the time period. The timer resets the accumulator at the start of each time period. The logic compares each net number to one or more thresholds and provides one or more operating indications based on the comparisons.

Other embodiments of the invention are also disclosed.

### BRIEF DESCRIPTION OF THE DRAWINGS

Illustrative and presently preferred embodiments of the invention are illustrated in the drawings, in which:

FIG. 1 illustrates an exemplary method for monitoring frequency corrections in a clock and data recovery phase-lock loop, and for deriving operating indications therefrom; and

FIG. 2 illustrates exemplary apparatus for monitoring frequency corrections in a clock and data recovery phase-lock loop, and for deriving operating indications therefrom.

### DESCRIPTION OF THE INVENTION

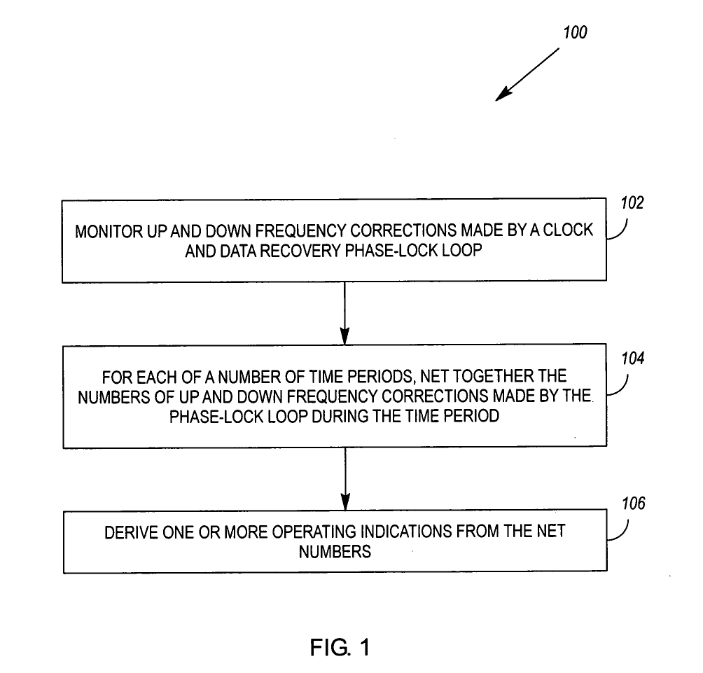

The error rate in data that is recovered by a clock and data recovery phase-lock loop should be roughly equivalent to the integrated frequency correction made by the phase-lock loop over a given time period. The method and apparatus illustrated in FIGS. 1 & 2 therefore provide means for monitoring frequency corrections in a clock and data recovery phase-lock loop, and for deriving operating indications (e.g., status and/or error indications) therefrom. In this manner, the existence and/or magnitude of the error rate in recovered data can be inferred.

The frequency corrections provided by a phase-lock loop are typically provided in the form of “up” and “down” voltage corrections (although other forms of correction are possible). As a result, the method 100 (FIG. 1) begins with the monitoring 102 of up and down frequency corrections made by a phase-lock loop. For each of a number of time periods, the numbers of up and down frequency corrections made by the phase-lock loop during the time period are netted together 104. These net numbers are then used 106 to derive one or more operating indications.

Optionally, the method 100 may de-serialize the monitored frequency corrections to form parallel “words” of frequency corrections. In this manner, the netting of frequency corrections may be undertaken at a frequency that is less than the operating frequency of the phase-lock loop. For example, if ten consecutive frequency corrections are merged into a 10-bit word, then the netting of frequency corrections can be undertaken at a frequency that is an order of magnitude less than the operating frequency of the phase-lock loop. Note that the time period over which frequency corrections are netted may be long enough to require the netting of frequency corrections contained in multiple parallel words.

Various operating indications may be derived, in various ways. By way of example, these operating indications may take the form of error and/or status indications. In one embodiment of the method 100, an error indication is generated whenever one of the net numbers is non-zero. In another embodiment, each net number is compared to one or more thresholds and, if any of the net numbers exceeds one of the thresholds, an error indication is generated. By way of example, the one or more thresholds could comprise a single threshold to which an absolute value of netted frequency corrections is compared. Or, the one or more thresholds could comprise positive and negative thresholds of different values to which a signed (i.e., positive or negative) net number is compared.

One way to generate an indication of whether a net number exceeds a threshold is to set a built-in self-test (BIST) sticky bit. BIST hardware may then be used to read the sticky bit and provide an error or status indication to a user, software or firmware that can determine how to handle same. In some embodiments, it may be desirable to have software or firmware make automatic adjustments to a phase-lock loop, in response to a received operating indication.

In yet another embodiment of the method 100, each net number is compared with a maximum of previously encountered net numbers. If a net number exceeds the maximum net number, the maximum net number is set to the net number that exceeds it. The maximum net number is then provided as an error or status indication.

The method 100 may further comprise outputting each of the net numbers. By way of example, the net numbers may be output to BIST hardware and then read therefrom.

The operating indications noted above may be used, for example, to infer the following. If a net number of frequency corrections in a given time period is non-zero, there is a greater chance that anomalous events in a received data stream are leading to errors in the data that is being recovered from the received stream. However, it may be decided that a given projected error rate is tolerable. In such a case, it may be desirable to set a non-zero threshold (or even set positive and negative thresholds) so that small net frequency corrections will not trigger an error indication. It is also possible that the tolerable error rate is not known. If not known, it may be useful to update and store a maximum net number, or even output each of the net numbers that are calculated. Very large net frequency corrections are likely to be indicative of a problem in the function of the phase-lock loop itself.

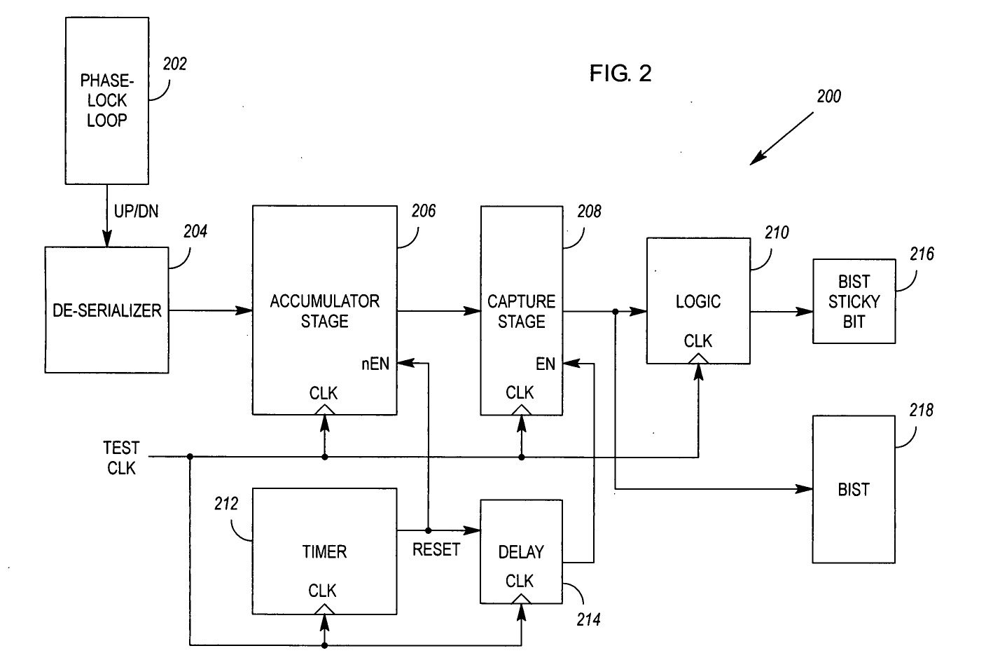

Exemplary apparatus 200 for monitoring frequency corrections in a clock and data recovery phase-lock loop 202, and for deriving operating indications therefrom, is shown in FIG. 2. In general, the apparatus 200 comprises an accumulator stage 206, a timer 212, and some logic 210. The accumulator stage 206 i) receives up and down frequency corrections from the phase-lock loop 202, and then ii) for each of a number of time periods, nets together the numbers of up and down frequency corrections that were received during the time period. The timer 212 resets the accumulator stage 206 at the start of each time period. The logic 210 compares the net numbers to one or more thresholds and then provides one or more operating indications based on the comparisons.

Optionally, a de-serializing stage 204 may be provided between the phase-lock loop 202 and the accumulator stage 206. In this manner, sets of the up and down frequency corrections may be provided to the accumulator stage 206 as parallel words of frequency corrections.

The apparatus 200 may also comprise a capture stage 208 to capture net numbers from the accumulator stage 206 and, at the end of each time period, provide a net number to the logic 210. The capture stage 208 is useful in preserving a net number after the accumulator stage 206 has begun compiling the net number for a next time period. In one embodiment of the apparatus 200, net numbers stored by the capture stage 208 are dumped to BIST hardware 218.

The accumulator stage 206, capture stage 208, timer 212 and logic 210 may all be clocked by a test clock (TEST CLK) having a frequency that is lower than that of the phase-lock loop 202. This is made possible, in part, by the de-serializing of frequency corrections into parallel words of frequency corrections.

The timer 212 may serve to not only reset the accumulator stage 206 but, after a delay, also reset the capture stage 208. In one embodiment, the timer 212 is implemented as a rollover counter.

The logic 210 may perform one or more of a number of functions. In one embodiment, the logic 210 determines whether any net number it receives is non-zero. If so, it provides an error indication by, for example, setting a BIST sticky bit 216. In another embodiment, the logic 210 provides an error indication if a net number exceeds any one of a plurality of thresholds, such as positive and negative thresholds. Again, this error indication may be provided by setting a BIST sticky bit 216.

In yet another embodiment, the logic 210 sets a threshold equal to a net number if the net number exceeds the threshold. In this manner, a threshold provides an indication of the maximum net frequency correction made by the phase-lock loop 202.

The output of logic 210 may also drive other registers, storage cells and/or logic, some of which may or may not be driven via the test clock (TEST CLK).

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method, comprising:
monitoring a number of up and down frequency corrections made by a clock and data recovery phase-lock loop;
for each of a number of time periods, netting together the number of up and down frequency corrections made by the phase-lock loop during the time period; and
deriving one or more operating indications from the net numbers.

2. The method of claim 1, further comprising:
de-serializing the monitored up and down frequency corrections to form parallel words of up and down frequency corrections; and
for each of the number of time periods, performing said netting on the up and down frequency corrections contained within one or more of the parallel words.

3. The method of claim 1, wherein said deriving comprises generating an operating indication if any one of the net numbers is non-zero.

4. The method of claim 3, wherein the operating indication is generated by setting a built-in self-test sticky bit.

5. The method of claim 1, wherein said deriving comprises:
comparing each net number to one or more thresholds; and
if any of the net numbers exceeds one of the thresholds, generating an operating indication.

6. The method of claim 5, wherein the operating indication is generated by setting a built-in self-test sticky bit.

7. The method of claim 5, wherein each of said net numbers is associated with a sign, and wherein the one or more thresholds comprise positive and negative thresholds.

8. The method of claim 1, wherein said deriving comprises:
comparing each net number to a maximum of previously encountered net numbers, and if a net number exceeds the maximum net number, setting the maximum net number to the net number; and
providing the maximum net number as one of the operating indications.

9. The method of claim 1, further comprising, outputting each of the net numbers to built-in self-test hardware.

10. Apparatus, comprising:
an accumulator stage to i) receive up and down frequency corrections from a clock and data recovery phase-lock loop, and ii) for each of a number of time periods, net together the number of up and down frequency corrections that were received during the time period;
a timer to reset the accumulator at the start of each time period; and
logic to compare each net number to one or more thresholds and provide one or more operating indications based on said comparisons.

11. The apparatus of claim 10, further comprising a de-serializing stage, between the phase-lock loop and the accumulator stage, to output sets of the up and down frequency corrections to the accumulator stage as parallel words of up and down frequency corrections.

12. The apparatus of claim 10, further comprising a capture stage to capture net numbers from the accumulator stage and, at the end of each time period, provide a net number to said logic.

13. The apparatus of claim 12, wherein net numbers stored by the capture stage are dumped to built-in self-test hardware.

14. The apparatus of claim 10, wherein said accumulator stage, timer and logic are clocked by a test clock having a frequency that is lower than that of the phase-lock loop.

15. The apparatus of claim 10, wherein said one or more thresholds is zero, and wherein said logic sets an operating indication if any of the net numbers is non-zero.

16. The apparatus of claim 10, wherein, if a net number exceeds one of said thresholds, said logic provides an operating indication by setting a built-in self-test sticky bit.

17. The apparatus of claim 10, wherein said logic sets a threshold equal to a net number if the net number exceeds the threshold.

18. Apparatus, comprising:
means for monitoring a number of up and down frequency corrections made by a clock and data recovery phase-lock loop;
means to, for each of a number of time periods, net together the number of up and down frequency corrections that were made by the phase-lock loop; and
means to derive one or more operating indications from the net numbers.
